(19) United States
(12) Patent Application Publication
(10) Pub. No.: US 2021/0150562 A1
(43) Pub. Date: May 20, 2021

(54) METHODS AND SYSTEMS FOR FACILITATING REWARD TRACKING AND REDEMPTION PLATFORM FOR AIRLINE TRAVELLERS

(71) Applicant: MASTERCARD INTERNATIONAL INCORPORATED, PURCHASE, NY (US)

(72) Inventors: Priyanshee PALRIWALA, Ahmedabad (IN); Dinesh Kumar LAL, Gurgaon (IN); Aditi GARG, Kota (IN)

(21) Appl. No.: 17/075,319

(22) Filed: Oct. 20, 2020

(30) Foreign Application Priority Data
Nov. 14, 2019 (SG) 10201910680X

(51) Int. Cl. G06Q 30/02; G06Q 50/14; G06Q 10/02; G06Q 20/04; G06Q 20/34

(52) U.S. Cl. CPC G06Q 30/0233; G06Q 50/14; G06Q 10/02; G06Q 20/18; G06Q 20/34; G06Q 30/0231; G06Q 30/0236; G06Q 20/0457

(57) ABSTRACT

Embodiments provide methods and server systems for facilitating reward tracking and redemption platform for airline travellers. A method includes receiving, by a server system associated with a payment network, an airline ticket booking notification including a booking information of an airline ticket purchased by a user using a payment card. Using a payment card information, the method includes checking if a Universal Account Number (UAN) is assigned to the user. If yes, the method includes retrieving the UAN. If not, the method includes assigning the UAN to the user. The method includes linking the UAN to the airline ticket. The method includes facilitating a reward tracking and redemption platform that at least includes one or more reward points assigned to the UAN. The one or more reward points are generated based on difference of a baggage weight carried by the user versus the baggage weight allowed by an airline enterprise.

### CROSS-REFERENCE TO RELATED APPLICATION

This application claims priority to Singapore Patent Application No. 10201910680X, filed Nov. 14, 2019, entitled “Methods and Systems for Facilitating Reward Tracking and Redemption Platform for Airline Travellers”, the entirety of which is incorporated herein by reference.

### TECHNICAL FIELD

The present disclosure relates to rewarding airline travellers and, more particularly to, methods and systems for facilitating a reward tracking and redemption platform based on a baggage weight carried by the airline traveller at the time of checking into the flight.

### BACKGROUND

Nowadays, many people opt for airline travels as the airline companies provide competitive costs, early booking discounts apart from being a time-efficient means of travel. As more and more people travel through airlines, the airline companies need to maintain various regulations such as baggage allowance, security checks, and the like. It is estimated that if every flight loses a kilogram of baggage weight, it can save more than hundred kilolitres of fuel every year which is equivalent to a huge amount of money saving for the airline company. In order to achieve fuel and cost savings and thereby increase the profits, excess baggage fees are becoming more popular with the airlines, particularly the budget airlines, as a way of seeking extra revenue from passengers. Each airline has developed its own baggage rules governing when and how much excess baggage fees it will charge. For example, any baggage that exceeds the provider-defined weight threshold is typically charged an additional fee that is proportionate with its measured weight.

Moreover, when a passenger has exceeded the baggage allowance, he is either forced to repack and discard luggage at the check-in counter, or he must pay for the excess baggage, sometimes at a different desk, before returning to complete the check-in procedure or baggage drop. This can be frustrating to the passenger, with the potential to cause delays and the possibility for the passenger to miss the flight. Thus, a penalizing system from the airline companies already exists that charges more for higher weight of the baggage, however, currently, there is no reward system available that encourages a passenger to carry baggage with lower weight and earn rewards for the same.

Accordingly, there is a need for techniques that inspire passengers into carrying under-limit weight baggage in flight through rewards, thereby, creating a win-win situation for the passengers and the airlines and, as a side beneficial effect, diverting the environment implications of air travel to a great extent.

### SUMMARY

Various embodiments of the present disclosure provide systems, methods, electronic devices and computer program products to facilitate reward tracking and redemption platform for airline travellers.

In an embodiment, a computer-implemented method is disclosed. The method includes receiving, by a server system associated with a payment network, an airline ticket booking notification. The airline ticket booking notification includes a booking information of an airline ticket purchased by a user using a payment card. Using a payment card information of the payment card, the method includes checking, by the server system, if a Universal Account Number (UAN) is assigned to the user. If the UAN is assigned to the user, the method includes retrieving, by the server system, the UAN based on receiving the airline ticket booking notification. If the UAN is not assigned to the user, the method includes assigning, by the server system, the UAN to the user. The method includes linking, by the server system, the UAN to the purchased airline ticket. The method includes facilitating, by the server system, a reward tracking and redemption platform. The reward tracking and redemption platform at least includes one or more reward points assigned to the UAN. The one or more reward points are generated based at least on difference of a baggage weight carried by the user versus the baggage weight allowed by an airline enterprise of the purchased airline ticket.

In another embodiment, a server system in a payment network is provided. The server system includes a communication interface configured to receive an airline ticket booking notification. The airline ticket booking notification includes a booking information of an airline ticket purchased by a user using a payment card. The server system includes a memory comprising executable instructions and a processor communicably coupled to the communication interface. The processor is configured to execute the instructions to cause the server system to at least check if a Universal Account Number (UAN) is assigned to the user using a payment card information of the payment card. If the UAN is assigned to the user, the server system is further caused to retrieve the UAN based on receiving the airline ticket booking notification. If the UAN is not assigned to the user, the server system is further caused to assign the UAN to the user. The server system is further caused to link the UAN to the purchased airline ticket. The server system is further caused to facilitate a reward tracking and redemption platform. The reward tracking and redemption platform at least includes one or more reward points assigned to the UAN. The one or more reward points are generated based at least on difference of a baggage weight carried by the user versus the baggage weight allowed by an airline enterprise of the purchased airline ticket.

In yet another embodiment, a computer program product is provided. The computer program product includes at least one non-transitory computer-readable storage medium. The computer-readable storage medium includes a set of instructions. The set of instructions when executed by one or more processors in an electronic device, cause the electronic device to at least receive an airline ticket booking notification. The airline ticket booking notification includes a booking information of an airline ticket purchased by a user using a payment card. The electronic device is further caused to check if a Universal Account Number (UAN) is assigned to the user using a payment card information of the payment card. If the UAN is assigned to the user, the electronic device is further caused to retrieve the UAN based on receiving the airline ticket booking notification. If the UAN is not assigned to the user, the electronic device is further caused to assign the UAN to the user. The electronic device is further caused to link the UAN to the purchased airline ticket. The electronic device is further caused to facilitate a reward tracking and redemption platform. The reward tracking and redemption platform at least includes one or more reward points assigned to the UAN. The one or more reward points are generated based at least on difference of a baggage weight carried by the user versus the baggage weight allowed by an airline enterprise of the purchased airline ticket.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment, related to at least some example embodiments of the present disclosure;

FIGS. 2A and 2B collectively represent an example representation of assigning a Universal Account Number (UAN) using corresponding User Interfaces (UIs) of a reward tracking and redemption platform facilitated on a user device, in accordance with an example embodiment;

FIG. 3 represents a sequence flow diagram representing assigning of the UAN based on an airline ticket purchased by a user using a payment card, in accordance with an example embodiment;

FIG. 4 represents a simplified block diagram representation of a plurality of factors considered to generate reward points, in accordance with an example embodiment;

FIG. 5 represents an example representation of a UI of the reward tracking and redemption platform enlisting a plurality of redemption options, in accordance with an example embodiment;

FIG. 6 illustrates a flow diagram of a method for facilitating the reward tracking and redemption platform for airline travellers, in accordance with an example embodiment;

FIG. 7 is a simplified block diagram of a server system, in accordance with one embodiment of the present disclosure; and

FIG. 8 shows simplified block diagram of a user device capable of implementing at least some embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details.

Reference in this specification to “one embodiment” or “an embodiment” means that a particular feature, structure, or characteristic described in connection with the embodiment is included in at least one embodiment of the present disclosure. The appearances of the phrase “in an embodiment” at various places in the specification are not necessarily all referring to the same embodiment, nor to separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

The term “payment account” used throughout the description refers to a financial account that is used to fund the financial transaction (interchangeably referred to as “payment transaction”). Examples of the payment account include, but are not limited to a savings account, a credit account, a checking account and a virtual payment account. The payment account may be associated with an entity such as an individual person, a family, a commercial entity, a company, a corporation, a governmental entity, a non-profit organization and the like. In some scenarios, a payment account may be a virtual or temporary payment account that can be mapped or linked to a primary payment account, such as those accounts managed by PayPal®, and the like.

The term “payment network”, used throughout the description, refers to a network or collection of systems used for transfer of funds through use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by Mastercard®, VISA®, Discover®, American Express®, etc.

The term “payment card”, used throughout the description, refers to a physical or virtual card linked with a financial or payment account that may be used to fund a financial transaction to a merchant or any such facility via the associated payment account. Examples of the payment card include, but are not limited to, debit cards, credit cards, prepaid cards, virtual payment numbers, virtual card numbers, forex cards, charge cards and stored-value cards. A payment card may be a physical card that may be presented to the merchant for funding the payment. Alternatively, or additionally, the payment card may be embodied in form of data (e.g., a digital token) stored in a user device, where the data is associated with the payment account such that the data can be used to process the financial transaction between the payment account and a merchant's financial account.

Overview

Various example embodiments of the present disclosure provide methods, systems, user devices and computer program products for facilitating a reward tracking and redemption program/platform for the airline travellers who carry under-limit baggage weight during their flights.

In various example embodiments, the present disclosure provides a server system configured to facilitate a reward tracking and redemption platform that includes one or more User Interfaces (UIs) using which the user is enabled to register on the platform to avail a plurality of features such as rewards earning, rewards tracking and rewards redemption. Upon successfully registering on the platform using a corresponding UI, the user is assigned a Universal Account Number (UAN) by the server system. The UAN is used by the user and the server system for rewards tracking purposes.

In one embodiment, the server system is configured to receive an airline ticket booking notification of an airline ticket purchased by a user using a payment card. The server system is an interchange server associated with a payment network. The server system is configured to retrieve a payment card information of the payment card used by the user to purchase the airline ticket. Using the payment card information of the payment card, the server system checks if a UAN is assigned to the user. If the user is already registered with the reward tracking and redemption platform, the UAN would already be assigned to the user. In that scenario, the server system retrieves the UAN from a database by identifying the user using the payment card information. If the UAN is not assigned to the user i.e. if the user is not already registered on the platform, but has only used the payment card to purchase the airline ticket, the server system is configured to assign a new UAN to the user. The server system also links the UAN to the purchased airline ticket in order to add applicable rewards.

In one embodiment, the one or more reward points are generated by calculating difference of a baggage weight carried by the user from the baggage weight allowed by an airline enterprise of the purchased airline ticket. For example, if the user is carrying 15 kilograms baggage weight and the baggage allowance for the purchased airline ticket is 20 kilograms, rewards points equal to 5 kilograms of the differences are assigned to UAN of the user. The conversion rate to generate the reward points is dependent on various other factors/parameters rather than only considering the baggage weight difference. For example, the one or more reward points are generated based on a time-duration of a travel route retrieved from a booking information of the purchased airline ticket. The booking information is retrieved by the server system from the airline ticket booking notification. In various scenarios, the one or more reward points are generated based on a frequency usage of the travel route, a popularity of the travel route, a popularity of the airline enterprise and the like.

In one embodiment, the server system is configured to facilitate one or more pre-travel promotional offers to the user via the airline enterprise for carrying an under-limit baggage weight. For example, the one or more pre-travel promotional offers are facilitated to the user based on a number of booked tickets for the travel route of the user, an estimation of total baggage weight that would be there for the travel route of the user, an estimation of the baggage weight of the user for the travel route of the user as determined from the past records and the like. Further, in order to encourage the user for carrying an under-limit baggage weight, the server system is configured to deduct one or more reward points by calculating difference between a higher baggage weight carried by the user and the baggage weight allowed by the airline enterprise of the purchased airline ticket.

As more and more reward points get accumulated to the UAN of the user, the user is enabled to redeem the accumulated rewards points using the reward tracking and redemption platform or in-person at the airport. For example, the one or more accumulated reward points may be redeemed by the user using a seat preference, a higher class lounge privileges, an assignment of the one or more reward points to another user, a purchase of an over-limit baggage weight, a purchase of an in-flight meal, a purchase of an in-flight itinerary payment, a cash redemption, a purchase from a different airline alliance and the like.

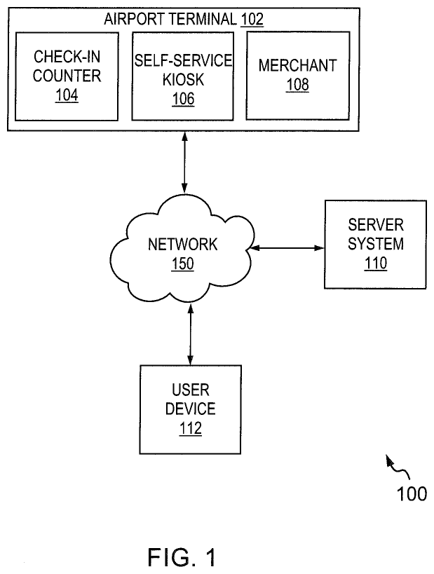

Various example embodiments of present disclosure are described hereinafter with reference to FIGS. 1 to 8.

FIG. 1 illustrates an example representation of an environment 100, in which at least some example embodiments of the present disclosure can be implemented. An airport terminal 102 is shown to include a check-in counter 104, a self-service kiosk 106 (hereinafter alternatively referred to as kiosk 106) and a merchant 108. The check-in counter 104 may be provided with a respective terminal for accessing passenger records via a computer network. The check-in counter 104 typically includes baggage weighing scales, usually mounted underneath a conveyer belt passing to the side of the check-in counter 104 for delivering the baggage to the baggage handling services.

The kiosk 106 may include any kiosk via which a traveler may perform travel-related functions and/or access travel-related information. For example, the kiosk 106 provides facilities such as check in for a flight, printing a boarding pass, change a seat on a flight, print an electronic ticket receipt, bag-drop, and the like. The kiosk 106 may also be provided with baggage weighing scales mounted underneath a conveyer belt passing to the side of the kiosk 106 for providing the bag drop facility. The merchant 108 may include any types of businesses carried by the merchant 108 in the airport terminal 102. For example, the merchant 108 may include retail stores, restaurants, spas, and the like. The airport terminal 102 may also include business class lounges for the passengers to relax. It is noted that the airport terminal 102 may include various other facilities for the passenger and there may be present a plurality of check-in counters per airline, a plurality of kiosks per airline and a plurality of merchants.

As part of the normal check-in procedure, a passenger/a traveller/a user is required to have his or her bags counted and weighed by an operator working for the airline company/airline enterprise, to check that the passenger is within the allowed baggage allowance for that airline for the ticket he/she is travelling on at the check-in counter 104. Alternatively, the traveller may be enabled to self-weigh the baggage at the kiosk 106. In at least one embodiment, if the traveller is carrying a baggage weight lesser than the baggage weight allowed by the airline company, the traveller is incentivized with applicable reward points that may be redeemed by the traveller for various air travel related purchases later.

To achieve this, a server system such as the server system 110 is disclosed. In one embodiment, the server system 110 is associated with a payment network (not shown). The payment network may be used by the payment cards issuing authorities as a payment interchange network. Examples of payment interchange network include, but not limited to, Mastercard® payment system interchange network. The Mastercard® payment system interchange network is a proprietary communications standard promulgated by Mastercard International Incorporated® for the exchange of financial transaction data amongst financial institutions that are members of Mastercard International Incorporated®. (Mastercard is a registered trademark of Mastercard International Incorporated located in Purchase, N.Y.). Further, Masterpass is a digital wallet facilitated by Mastercard® payment system interchange network that allows the user to check out by storing payment and shipping information in one secure location for a simple, fast, and secure checkout experience on online purchases as well as in shops. For example, instead of filling in or typing his or her e-mail address and a password or providing other information to proceed on a checkout page, the user may be prompted to directly sign into a particular Masterpass wallet for selecting a particular payment card account and/or shipping address and the like, to complete the purchase.

In a scenario, a user (not shown) purchases an airline ticket from an airline website running on his user device 112 using a payment card. Examples of the user device 112 include, but are not limited to, a personal computer (PC), a mobile phone, a tablet device, a Personal Digital Assistant (PDA), a voice activated assistant, a Virtual Reality (VR) device, a smartphone and a laptop. Alternatively, the airline ticket may be purchased from any of an airline mobile application, a travel agency, via a tele booking, in-person purchase from the airport or via Masterpass® wallet application. A financial institution normally called as an “issuer bank” or “issuing bank” or simply “issuer”, in which the user may have an account issues a payment card, such as a credit card or a debit card to the user.

Once the ticket is purchased using the payment card, an acquirer server associated with the airline enterprise sends the payment card information of the payment card to the payment interchange server i.e. the server system 110 for verification of the payment card and the cardholder via the payment network. Example of the payment card information include a payment card number (e.g., xxxx xxxx xxxx xxxx where ‘x’ is an integral number) of the payment card, an expiry date (e.g., MM/YYYY, month and year of expiry), a Card Verification Value (CVV) number (e.g., *** where * is an integral number) and the like. Alternatively, the payment card information may include information such as cardholder's payment account number, or any identification number associated with the payment card.

Using the payment card information, the server system 110 is configured to check if a Universal Account Number (UAN) is assigned to the user. In at least one embodiment, the UAN is used by the server system 110 to assign one or more reward points to the passenger/user by calculating difference of a baggage weight carried by the user versus the baggage weight allowed by the airline enterprise of the purchased airline ticket. In another embodiment, the UAN is used by the user at various participating airline enterprises to redeem the accumulated reward points earned by carrying under-limit baggage weight.

Further, in order to provide the access of the earned/accumulated reward points and their redemption to the user, the server system 110 is configured to facilitate a reward tracking and redemption platform. The reward tracking and redemption platform is facilitated by means of a web application or a mobile application that can run on the user device 112. The reward tracking and redemption platform facilitated by means of a web application or a mobile application (e.g., Masterpass facilitated by Mastercard® payment system interchange network) that includes one or more User Interfaces (UIs) for reward tracking and redemption is hereinafter alternatively referred to as a reward application that can run on the user device 112. The reward application allows the user to track his accumulated reward points and redeem the accumulated reward points for future purchases.

In one example embodiment, the server system 110 may store the reward application and provision instances of the application to end-users on their respective user devices for facilitating the reward tracking and redemption. The end-users may request the server system 110 to provision access to the reward application over a network 150. The application may thereafter be downloaded on the user devices (such as the user device 112) of the respective end-users in response to their request for access to the application. Alternatively, in some embodiments, the application may be factory installed within the user devices associated with the end-users and, as such, the users may not need to explicitly request the application from the server system 110.

The server system 110 is shown in communication with the airport terminal 102 and the user device 112 via a network such as the network 150. Examples of the network 150 may include any type of wired network, wireless network, or a combination of wired and wireless networks. A wireless network may be a wireless local area network (“WLAN”), a wireless wide area network (“WWAN”), or any other type of wireless network now known or later developed. Additionally, the network 150 may be or include the Internet, intranets, extranets, microwave networks, satellite communications, cellular systems, personal communication services (“PCS”), infrared communications, global area networks, or other suitable networks, etc., or any combination of two or more such networks.

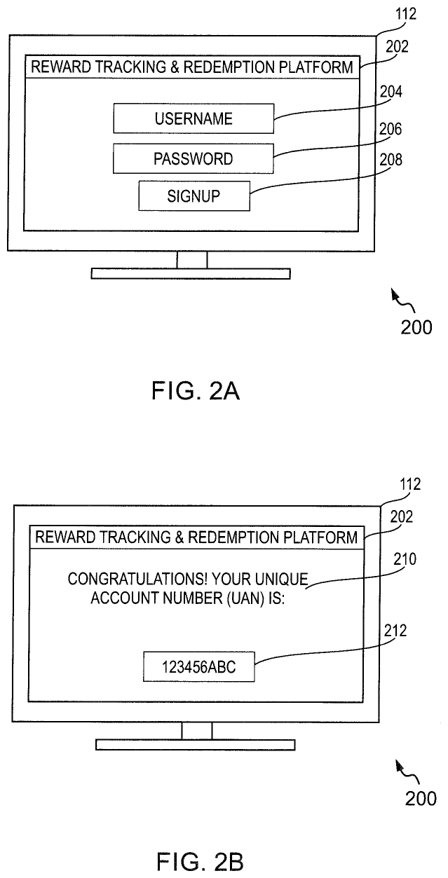

Since the user is encouraged to carry under-limit baggage weight by way of rewards, the airline industry saves a fortune on the fuel consumption. Further, as the rewards are redeemable at various associated merchant facilities of the airport, their businesses also get profited. Rather than providing only frequent flying benefits to the traveller by the airline industry, by using the embodiments of the present disclosure, the user in incentivized for carrying lesser baggage weight which results in an additional, not yet recognized, benefit for the airline industry. For instance, if a lower than average baggage load is anticipated, the airline may opt to transport commercial cargo on the flight, thereby creating an additional revenue source. Some non-exhaustive example embodiments of facilitating the reward tracking and redemption platform to the airline travellers are described with reference to the following description, particularly with reference to FIG. 2A-2B to FIG. 5.

FIGS. 2A and 2B collectively represent an example representation of assigning a Universal Account Number (UAN) using corresponding User Interfaces (UIs) 200A and 200B of a reward tracking and redemption platform facilitated on a user device, in accordance with an example embodiment. FIG. 2A represents a UI 200A displaying a sign-up/login page of the reward application running on the user device 112.

As shown in the UI 200A, a header 202 of the reward application displaying text ‘reward tracking and redemption platform’ is shown. Form fields 204 and 206 respectively seek a username and a password to be entered from the user for signing up for the application. For example, the user may enter ‘john@example.com’ as a username in the form field 204 and a password of his choice in the form field 206. Upon entering the required information, the user may click a button 208 labeled as ‘Sign-up’ to complete the user registration process. The server system 110, upon receiving a registration request from the user, is configured to provide the user an access to the reward application to utilize various features of the reward application. Further, upon successfully registering the user, the server system 110 is configured to assign a UAN to the user.

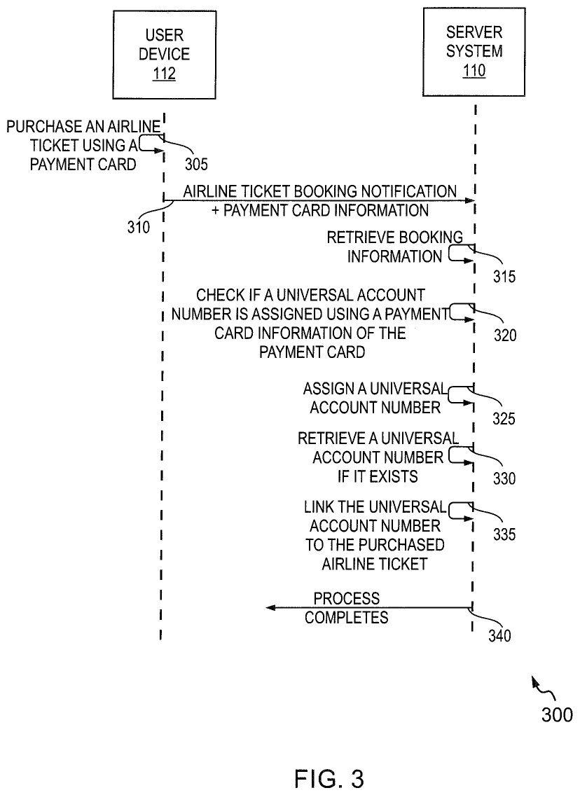

This is shown with reference to FIG. 2B that represents a UI 200B. The UI 200B displays a message 210 displaying text, ‘congratulations! Your Universal Account Number (UAN) is:’. The UAN is displayed using an information field 212. The UAN is exemplarily displayed as ‘123456ABC’. Thus, the assignment of a UAN to a newly registered user is completed by the server system 110. In at least one embodiment, even if a user is not registered on the reward application, a corresponding UAN is assigned to the user by the server system 110. This is explained in detail with reference to FIG. 3 hereinafter.

FIG. 3 represents a sequence flow diagram 300 representing assigning of the UAN based on an airline ticket purchased by a user using a payment card, in accordance with an example embodiment.

At 305, a user purchases an airline ticket from an airline website running on the user device 112 using a payment card. As soon as the ticket is purchased, the payment card information and an airline ticket booking notification are sent by an acquirer of the airline enterprise to the server system 110 (see, 310). The airline ticket booking notification includes booking information of the purchased ticket. Examples of the booking information include, but are not limited to, a time-duration of a travel route, traveller information (e.g., name, address, mobile number, email ID and the like), flight information (e.g., date, time, name of the airline, originating and terminating locations, flight number and the like), and the like.

At 315, the server system 110 is configured to retrieve the booking information. In one embodiment, the booking information is stored in a database of the server system 110 and later utilized to determine one or more rewards points for the traveller.

At 320, the server system 110 is configured to check if a UAN is assigned to the user using the payment card information of the user. In at least one embodiment, the UAN is always associated with the payment card of the user. Therefore, at first, the server system 110 is configured to identify and verify the user by matching the payment card information received from the acquirer with the payment card information stored in the database of the server system 110. If both payment card information match successfully, the user is identified and verified. Thereafter, the server system 110 checks if the UAN is stored against the payment card of the user in the database.

At 325, if a UAN does not exist, the server system 110 is configured to assign a UAN to the user. The assigned UAN is stored against payment card of the user that was used to purchase the airline ticket in the database of the server system 110. As explained with reference to FIG. 2, if the user has already registered himself on the reward application, a UAN is automatically assigned to him upon completion of the registration and stored against a payment card of the user.

Therefore, at 330, the UAN is retrieved if it is already assigned to the user. The UAN helps the user to receive rewards even from purchasing an airline ticket from an affiliated travel agency. For example, after purchasing the ticket from the affiliated travel agency, the user may be enabled to provide the UAN to the travel agency for adding the applicable reward points for the purchase.

At 335, the UAN is linked to the purchased airline ticket by the server system 110. The UAN generation process completes at step 340.

In one embodiment, upon generation and assignment of the UAN, and linking the UAN with the purchased airline ticket, when the user reaches the check-in counter 104 with his baggage to compete the check-in procedure, his baggage weight is calculated by the operator. If the baggage weight is less than the threshold limit, the difference amount of the baggage weight is sent by the airport terminal 102 to the server system 110 via the network 150. The server system 110 is configured to convert the difference amount to equivalent reward points and assign those reward points to the UAN of the user.

In one example embodiment, the reward point conversion of the excess weight varies from airline to airline based on the partnership with reward tracking and redemption platform. For example, in case of an excess baggage, reward points equivalent to the difference amount of the baggage weight are deducted by the server system 110 along with the monetary compensation charged by the airline enterprise. This feature additionally encourages the user to carry lesser baggage weight for not losing the already earned rewards in past. The more a passenger contributes in fuel saving to the airline, the more he is rewarded by the server system 110, thus motivating the passenger to carry lighter luggage.

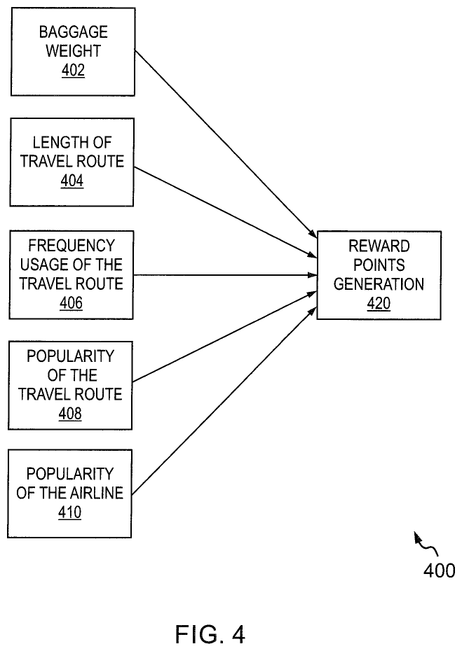

In at least one embodiment, the user is enabled to redeem the accumulated rewards points in future. For example, the passenger would be entitled to use the reward points on his further bookings via payment card-based transactions on any airline in the existing network. For instance, if the user intends to book an airline ticket from India to New York, the user can use the existing rewards for paying a certain portion of that ticket by providing the UAN straight away at the booking portal so as to redeem those rewards. Thus, using a single UAN, the user, the airline enterprise and the server system 110 are enabled to coordinate with one another to manage and redeem rewards with less complexity. The UAN is also used to track user behaviour in future transactions. In one embodiment, apart from the difference of the baggage weight carried by the user, the server system 110 is configured to consider various other factors to determine the reward points for the travel route of the user. This is explained in detail with reference to FIG. 4 hereinafter.

FIG. 4 represents a simplified block diagram representation 400 of a plurality of factors considered to generate reward points, in accordance with an example embodiment. A plurality of factors such as a baggage weight 402, a length (i.e., a time-duration) of the travel route 404, a frequency usage of the travel route 406, a popularity of the travel route 408, and a popularity of the airline 410 is considered by the server system 110 for reward points generation 420.

The baggage weight 402 based reward points generation 420 is explained hereinabove with reference to FIG. 3. Further, in an example embodiment, the server system 110 may calculate a simple average or arithmetic mean of historically carried baggage weight percentages with respect to the allowed baggage weight of a passenger and may determine that the passenger carries a consistently higher baggage weight. That value may be used by the server system 110 to provide more reward points to the passenger to encourage him to carry lower baggage weight.

The length of the travel route 404 is considered in terms that the longer routes are prone to higher baggage weights carried by the passengers. Therefore, the longer routes will have a reward points conversion factor different than the shorter routes. For example, the traveler travelling on an international flight carrying under-limit baggage weight is provided more rewards/reward points compared to another traveler travelling on a domestic flight carrying the same amount of under-limit baggage weight.

The frequency of usage of the travel route 406 is considered in terms of both the individual airline, as well as the airline industry as a whole. More frequently used travel routes have a higher conversion factor to determine the reward points. For example, a traveler travelling on a particular travel route is tracked to know which airline is used by the traveler to travel that particular route every time and based on that the reward points are determined.

The popularity of the travel route 408 (i.e., traffic on the travel route) is considered in terms of number of individuals travelling via the travel route. More popular routes with higher weight carrying passengers have a lower conversion factor. Similarly, popularity of the airline 410 is considered in terms that popular airlines may have higher conversion factor to determine the reward points. In one embodiment, the airline enterprise provides the actual data called addendum data (e.g., route start and end date, destinations, length of travel history etc.) relevant to the above mentioned factors to the server system 110 to generate the reward points. For example, an airline may opt to monitor and evaluate the baggage history for selected travellers over a designated period (e.g., the preceding 5 years, the last 20 flights, etc.) and send the corresponding data to the server system 110 to create rewards or merits.

An example of considering the flight timings (one more example of a factor for reward points generation 420) of two passengers for the same travel route for determining their respective reward points is explained in hereinafter. A passenger is traveling on a Delhi-Mumbai flight (which is heavily booked being a popular route) at 2:00 pm in the afternoon. Another passenger is travelling on the same route using the same airline at 1:00 am in the early morning. Apparently, the amount of weight carried by the passenger at 2:00 pm flight would be different than the amount of weight carried by the passenger at 1:00 am. This scenario will have different implications on reward points generation 420. Both the passengers will not get the same kind of benefits and the point consumption even if coincidently they happen to carry the same amount of under-limit baggage weight. Further, a person travelling with family generally carries more baggage weight than travelling alone. This will again change the implications of the reward points generation 420.

In one example embodiment, a colour-based score, or level, or a numeric value (examples of the reward points) that is calculated based on measured bag weights as a percentage of its designated flight allotment may be represented to the user using various UIs (not shown) by the server system 110. For example, a colour based score may be represented by way of a bar which has a starting value of zero kilogram that corresponds to certain reward points (e.g., one thousand reward points) and an ending value of maximum baggage allowance that corresponds to zero reward point. A level-based reward points may be represented by way of allotment ranges, e.g., zero to five kilograms would provide one thousand reward points, five to ten kilograms would provide five-hundred reward points and so on. By looking at such graphical representation, the user is enabled to determine how much baggage he should carry for the upcoming flight to earn the desired reward points.

In one embodiment, the server system 110 is configured to facilitate one or more pre-travel promotional offers to the user via the airline enterprise for carrying an under-limit baggage weight. The one or more pre-travel promotional offers are facilitated to the user based on a number of booked tickets for the travel route of the user, an estimation of total baggage weight for the travel route of the user and an estimation of the baggage weight of the user. The estimation of total baggage weight for the travel route of the user is calculated using a predictive algorithm which may take into account other factors such as the previous luggage weight records of the users. The estimation of the baggage weight of the users is considered as a method to discourage users who have a previous record of carrying heavier luggage weight. Further, the airline company gets an option to streamline the weight across routes for each of its flights by targeting the user, through promotions, to carry lesser weight considering the current occupancy. Accordingly, the rewards can be increased or decreased based on the route's demand and supply.

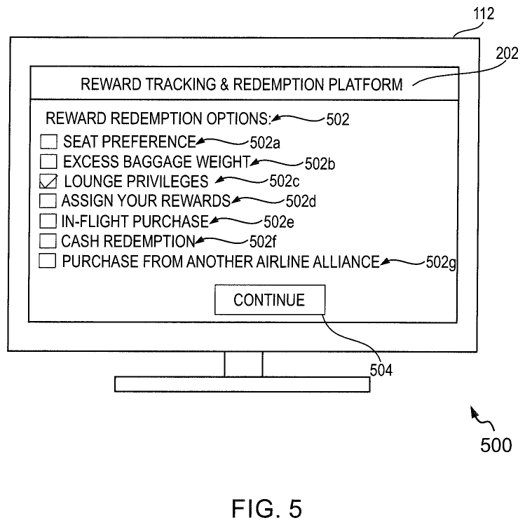

Thus, various embodiments of present disclosure provide an end-to-end weight-based reward system with emphasis on processes for reward generation, targeted promotional marketing and reward redemption presenting a holistic view of the system. Further, the generated rewards are available on the user's payment card itself. The rewards can be redeemed by swiping the payment card itself, hence reducing the need of additional infrastructure. Additional features of rewards redemption are explained in detail with reference to FIG. 5 hereinafter.

FIG. 5 represents an example representation of a UI 500 of the reward tracking and redemption platform enlisting a plurality of redemption options, in accordance with an example embodiment. As explained with reference to FIGS. 2A and 2B, if the user has already registered on the reward application, a UAN gets assigned to him. The UAN helps the user to redeem the accumulated reward points on the spot at the airport terminal 102 or via the reward application. Accordingly, the reward application/the reward tracking and redemption platform header 202 facilitates the UI 500 on the user device 112 displaying a plurality of reward redemption options 502 such as a seat preference 502a, an excess baggage weight 502b, lounge privileges 502c, assign your rewards 502d (i.e., an assignment of the one or more reward points to another user), an in-flight purchase 502e, a cash redemption 502f, a purchase from another airline alliance 502g and the like.

The lounge privileges 502c are shown to be selected by the user. Upon selecting preferred redemption option, the user may click a button 504 labelled ‘Continue’ to submit the option. The server system 110, upon receiving the user preference from the reward application, is configured to notify the airport terminal 102 of the user preference to make necessary arrangements. For example, the server system 110 communicates with a computer network of a corresponding business class lounge present at the airport terminal 102 via the network 150 such that when the user reaches the lounge, he is only required to provide the UAN to the operator for verification and gets the entry to the lounge.

In one example embodiment, the user is enabled to divide the accumulated reward points amongst more than one redemption options displayed on the UI 500. For example, if the user has one thousand reward points assigned to the UAN currently, then he may use two-hundred reward points for the seat preference 502a, six-hundred reward points for an excess baggage weight 502b that he intends to carry for the upcoming travel and still keep a balance of reaming two-hundred reward points. Upon selecting and submitting more than one reward redemption options 502 on the UI 500, the reward application may direct the user to another UI (not shown) where he is enabled to distribute the reward points among the preferences. In another example embodiment, the reward points can be redeemed in some other form of already existing frequent flyer programs run by the airline enterprise.

From the foregoing embodiments and associated examples, it will be appreciated that the capability described herein provides various benefits for all interested parties, including but not limited to the airline travellers, airports, airlines, businesses/merchants located within airports, airline clubs, and the like. Further, the server system 110 provides a mechanism to enroll on the reward tracking and generation platform through various means (e.g., online during a booking process and after completing the booking, online through an enrollment page (e.g., the reward application) even if not booking travel, from a call center, from a third-party system using web service, etc.).

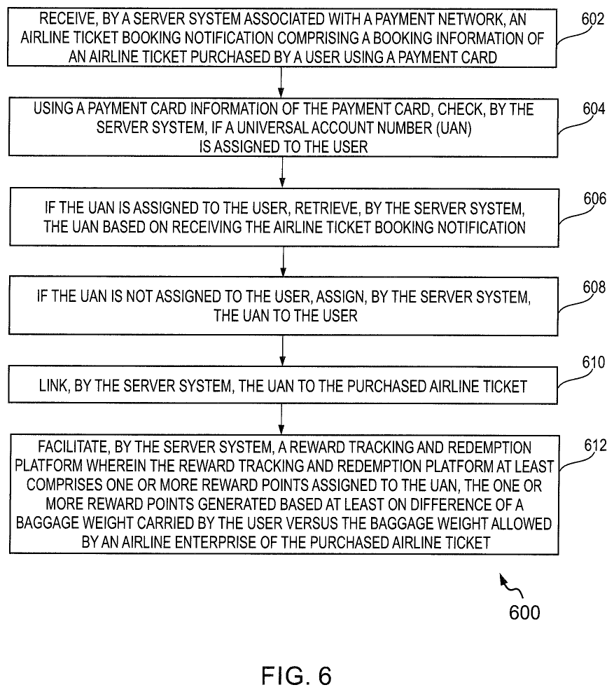

FIG. 6 illustrates a flow diagram of a method 600 for facilitating the reward tracking and redemption platform for airline travellers, in accordance with an example embodiment. The method 600 depicted in the flow diagram may be executed by, for example, at least one server system such as the server system 110 explained with reference to FIG. 1. Operations of the flow diagram shown in FIG. 6, and combinations of operations in the flow diagram of FIG. 6, may be implemented by, for example, hardware, firmware, a processor, circuitry and/or a different device associated with the execution of software that includes one or more computer program instructions. The operations of the method 600 are described herein with the help of the server system 110. It is noted that the operations of the method 600 can be described and/or practiced by using a system other than the server system 110. The method 600 starts at operation 602.

At 602, the method 600 includes receiving, by a server system (e.g., the server system 110) associated with a payment network, an airline ticket booking notification. The airline ticket booking notification includes a booking information of an airline ticket purchased by a user using a payment card. The booking information includes a time-duration of a travel route among other information such as date, source and destination and the like.

At 604, the method 600 includes, checking, by the server system, if a Universal Account Number (UAN) is assigned to the user using a payment card information of the payment card.

If the UAN is assigned to the user, at 606, the method 600 includes retrieving, by the server system, the UAN based on receiving the airline ticket booking notification.

If the UAN is not assigned to the user, at 608, the method 600 includes assigning, by the server system, the UAN to the user.

At 610, the method 600 includes linking, by the server system, the UAN to the purchased airline ticket.

At 612, the method 600 includes facilitating, by the server system, a reward tracking and redemption platform. The reward tracking and redemption platform at least includes one or more reward points assigned to the UAN. The one or more reward points are generated based at least on difference of a baggage weight carried by the user versus the baggage weight allowed by an airline enterprise of the purchased airline ticket. The method 600 ends at step 612. Further, the one or more reward points are generated based on one of a frequency usage of the travel route, a popularity of the travel route, a popularity of the airline enterprise, a time-duration of the travel route or a combination thereof. The server system further facilitates redemption of the one or more reward points accumulated by the user using one of a seat preference, a higher class lounge privileges, an assignment of the one or more reward points to another user, a purchase of an over-limit baggage weight, a purchase of an in-flight meal, a purchase of an in-flight itinerary payment, a cash redemption, a purchase from a different airline alliance and the like.

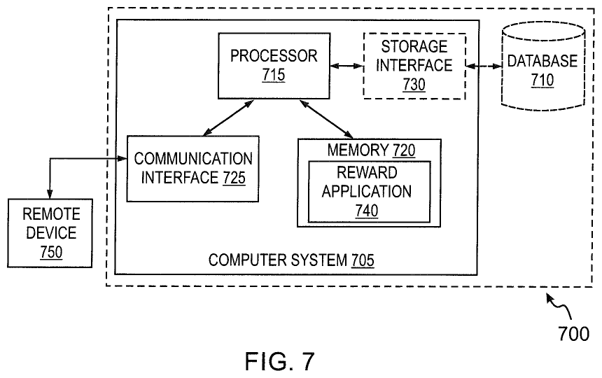

FIG. 7 is a simplified block diagram of a server system 700, in accordance with one embodiment of the present disclosure. The server system 700 is an example of a server system that is a part of the payment network. Example of the server system 700 includes, but is not limited to, the server system 110 of FIG. 1. As explained with reference to FIG. 1, the server system 110 is associated with a payment network that may be used by a wallet server, an issuer server and an acquirer server as a payment interchange network. Examples of the payment interchange network include, but not limited to, Mastercard® payment system interchange network. The server system 700 includes a computer system 705 and a database 710. The components of the server system 700 provided herein may not be exhaustive, and that the server system 700 may include more or fewer components than those depicted in FIG. 7. Further, two or more components may be embodied in one single component, and/or one component may be configured using multiple sub-components to achieve the desired functionalities. Some components of the server system 700 may be configured using hardware elements, software elements, firmware elements and/or a combination thereof.

The computer system 705 includes at least one processor 715 for executing instructions. Instructions may be stored in, for example, but not limited to, a memory 720. The processor 715 may include one or more processing units (e.g., in a multi-core configuration). The memory 720 includes machine executable instructions for a reward application 740. The memory 720 can be any type of storage accessible to the processor 715. For example, the memory 720 may include volatile or non-volatile memories, or a combination thereof. In some non-limiting examples, the memory 720 can be four to sixty-four Megabytes (MB) of Dynamic Random Access Memory (“DRAM”) or Static Random Access Memory (“SRAM”). In addition, some examples may include supplementary flash memory installed via a PCMCIA slot.

The processor 715 is operatively coupled to a communication interface 725 such that the computer system 705 is capable of communicating with a remote device 750 such as the user device 112, the airport terminal 102 or communicating with any entity (e.g., an acquirer server, an issuer server, a wallet server, a third-party travel agency server etc.) within the payment network. For example, the communication interface 725 may receive an airline ticket booking notification of an airline ticket purchased by a user using a payment card. The communication interface 725 is further configured to cause display of user interfaces on the remote device 750. The communication interface 725 may also receive a request for registration on the reward application 740 by a user using a corresponding UI. In one embodiment, the communication interface 725 includes a transceiver for wirelessly communicating information to, or receiving information from, the remote device 750 or other suitable display device, and/or another type of remote processing device. In another embodiment, the communication interface 725 is capable of facilitating operative communication with the remote devices and a cloud server using Application Program Interface (API) calls. The communication may be achieved over a communication network, such as the network 150.

The processor 715 may also be operatively coupled to the database 710. The database 710 is any computer-operated hardware suitable for storing and/or retrieving data, such as, but not limited to, transaction data generated as part of sales activities conducted over the bankcard network including data relating to merchants (e.g., merchants at the airport terminals, affiliated merchants registered for reward tracking and redemption platform, participating airlines etc.), account holders or customers, and purchases. The database 710 may also store information related to a plurality of user's payment accounts. Each user account data includes at least one of a username, a user address, an account number, PIN, and other account identifiers. The database 710 may also store device identifiers and the digital tokens.

The database 710 may also store a merchant identifier that identifies each merchant registered to use the payment network, and instructions for settling transactions including merchant bank account information (e.g., a plurality of payment accounts related to the merchant interfaces associated with merchants). The database 710 may include data related to a merchant, such as, but not limited to, a merchant primary account number (PAN), a merchant name, a merchant category code (MCC), a merchant city, a merchant postal code, a merchant brand name, a merchant ID and the like. The processor 715 is configured to use the merchant ID to identify the merchant during the normal processing of payment transactions, adjustments, chargebacks, end-of-month fees and so forth. The database 710 may further include issuer account information. The database 710 may also include a list of affiliated merchants on the airport terminal to facilitate the user with reward redemption.

The database 710 may further include information associated with the account of the user/traveller (e.g., e-currency, e-coupons, e-vouchers, e-discounts, e-offers, reward points, and the like), booking information of an airline ticket purchased by the user using a payment card, transaction history information of the traveller (e.g., which may be used for determining the reward points), the UAN of the user, redemption history of the user, baggage weight measurements history and the like, as well as various combinations thereof. The database 710 may include information such as a frequency usage of the travel route, a popularity of the travel route, a popularity of the airline enterprise and the like as received from the airport enterprise via the communication interface 725.

The database 710 may include multiple storage units such as hard disks and/or solid-state disks in a redundant array of inexpensive disks (RAID) configuration. The database 710 may include a storage area network (SAN) and/or a network attached storage (NAS) system. In some embodiments, the database 710 is integrated within the computer system 705. For example, the computer system 705 may include one or more hard disk drives as the database 710. In other embodiments, the database 710 is external to the computer system 705 and may be accessed by the computer system 705 using a storage interface 730. The storage interface 730 is any component capable of providing the processor 715 with access to the database 710. The storage interface 730 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 715 with access to the database 710.

In an embodiment, the processor 715 may be embodied as one or more of various processing devices, such as a coprocessor, a microprocessor, a controller, a digital signal processor (DSP), processing circuitry with or without an accompanying DSP, or various other processing devices including integrated circuits such as, for example, an application specific integrated circuit (ASIC), a field programmable gate array (FPGA), a microcontroller unit (MCU), a hardware accelerator, a special-purpose computer chip, or the like.

The processor 715 is capable of executing the stored machine executable instructions of the reward application 740 in the memory 720 or within the processor 715 or any storage location accessible to the processor 715. The processor 715, via the communication interface 725 is configured to facilitate one or more UIs of the reward application 740 on the remote device 750 e.g., the user device 112 so as to enable the user to register for the reward tracking and redemption platform. Upon successfully registering the user, the processor 715 is configured to assign the UAN to the user.

The processor 715 is configured to perform the various operations as explained with reference to method 600. For example, the processor 715 is configured to receive an airline ticket booking notification that includes a booking information of an airline ticket purchased by a user using a payment card via the communication interface 725. The processor 715 is configured to look up the database 710 for retrieving the UAN of the user using the payment card information of the payment card. If not available, the processor 715 is configured to generate/assign the UAN to the user.

Further, the processor 715 is configured to link the UAN to the airline ticket using the booking information of the airline ticket. Linking of the UAN to the purchased airline ticket results in the one or more reward points being added to the UAN at least by calculating the difference of the baggage weight carried by the user versus the baggage weight allowed by the airline enterprise of the purchased ticket. Linking of the UAN to the purchased airline ticket further enables the user to redeem the one or more accumulated reward points using the corresponding UI of the reward application 740 or in-person at the airport terminal (e.g., the airport terminal 102 of FIG. 1). The aggregation of baggage weight measurements in the database 710 as utilized by the processor 715 over an extended period of time introduces a number of notable, previously unrealized advantages to the user and the airline enterprise. Apart from the baggage weight measurements, the processor 715 is configured to utilize other factors (e.g., the frequency of the travel route) as stored in the database 710 to determine one or more reward points.

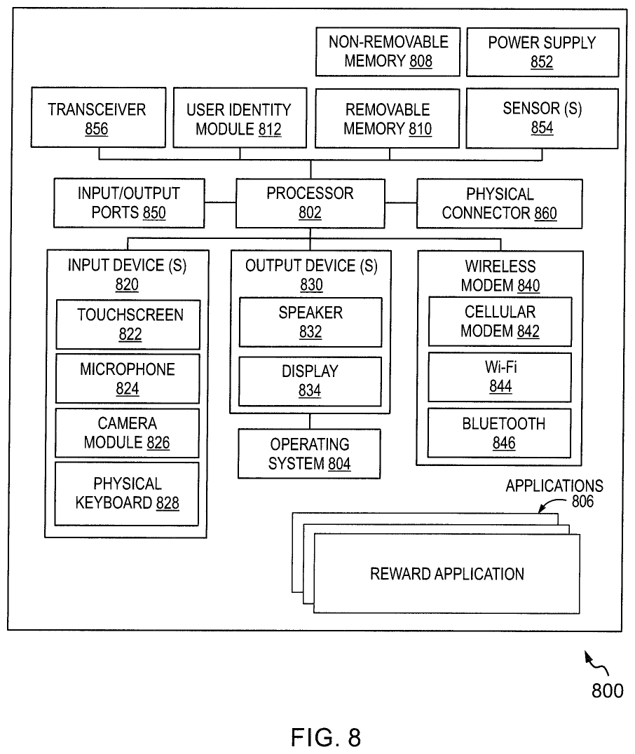

FIG. 8 shows simplified block diagram of a user device 800, for example, a mobile phone or a desktop computer capable of implementing the various embodiments of the present disclosure. For example, the user device 800 may correspond to the user device 112 of FIG. 1. The user device 800 is depicted to include one or more applications, such as a reward application. The reward application can be an instance of an application downloaded from the server system 110. The reward application 806 is capable of communicating with the server system 110 for facilitating the user with a UAN linked to a purchased airline ticket for earning and redemption of one or more reward points.

It should be understood that the user device 800 as illustrated and hereinafter described is merely illustrative of one type of device and should not be taken to limit the scope of the embodiments. As such, it should be appreciated that at least some of the components described below in connection with the user device 800 may be optional and thus in an example embodiment may include more, less or different components than those described in connection with the example embodiment of the FIG. 8. As such, among other examples, the user device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated user device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the user device 800 and support for one or more reward tracking and redemption applications programs (see, the applications 806) such as the reward application, that implements one or more of the innovative features described herein. In addition to the payment application, the applications 806 may include merchant application, common mobile computing applications (e.g., telephony applications, email applications, calendars, contact managers, web browsers, messaging applications) or any other computing application.

The illustrated user device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The user device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in form of the SIM card is well known in Global System for Mobile Communications (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The user device 800 can support one or more input devices 820 and one or more output devices 830. Examples of the input devices 820 may include, but are not limited to, a touch screen 822/a display screen (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in the FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the user device 800 and a public switched telephone network (PSTN).

The user device 800 can further include one or more input/output ports 850, a power supply 852, one or more sensors 854 for example, an accelerometer, a gyroscope, a compass, or an infrared proximity sensor for detecting the orientation or motion of the user device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed method 600 with reference to FIG. 6, or one or more operations of the flow diagram may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, net book, Web book, tablet computing device, smart phone, or other mobile computing device). Such software may be executed, for example, on a single local computer or in a network environment (e.g., via the Internet, a wide-area network, a local-area network, a remote web-based server, a client-server network (such as a cloud computing network), or other such network) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application specific integrated circuit (ASIC) circuitry and/or in Digital Signal Processor (DSP) circuitry).

Particularly, the server system 700 and its various components such as the computer system 705 and the database 710 may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer readable media. Non-transitory computer readable media include any type of tangible storage media. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer readable media. Examples of transitory computer readable media include electric signals, optical signals, and electromagnetic waves. Transitory computer readable media can provide the program to a computer via a wired communication line (e.g. electric wires, and optical fibers) or a wireless communication line.

Various embodiments of the invention, as discussed above, may be practiced with steps and/or operations in a different order, and/or with hardware elements in configurations, which are different than those which, are disclosed. Therefore, although the invention has been described based upon these exemplary embodiments, it is noted that certain modifications, variations, and alternative constructions may be apparent and well within the spirit and scope of the invention.

Although various exemplary embodiments of the invention are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
receiving, by a server system associated with a payment network, an airline ticket booking notification comprising a booking information of an airline ticket purchased by a user using a payment card;
using a payment card information of the payment card, checking, by the server system, if a Universal Account Number (UAN) is assigned to the user;
if the UAN is assigned to the user, retrieving, by the server system, the UAN based on receiving the airline ticket booking notification;
if the UAN is not assigned to the user, assigning, by the server system, the UAN to the user;
linking, by the server system, the UAN to the purchased airline ticket; and
facilitating, by the server system, a reward tracking and redemption platform wherein the reward tracking and redemption platform at least comprises one or more reward points assigned to the UAN, the one or more reward points generated based at least on difference of a baggage weight carried by the user versus the baggage weight allowed by an airline enterprise of the purchased airline ticket.

2. The method as claimed in claim 1, wherein the one or more reward points are generated based on a time-duration of a travel route retrieved from the booking information of the purchased airline ticket.

3. The method as claimed in claim 2, wherein the one or more reward points are generated based on one of:
a frequency usage of the travel route;
a popularity of the travel route; and
a popularity of the airline enterprise.

4. The method as claimed in claim 1, further comprising:
facilitating one or more pre-travel promotional offers to the user via the airline enterprise for carrying an under-limit baggage weight, wherein the one or more pre-travel promotional offers are facilitated to the user based on a number of booked tickets for a travel route of the user.

5. The method as claimed in claim 4, wherein the one or more pre-travel promotional offers are facilitated to the user based on an estimation of total baggage weight for the travel route of the user.

6. The method as claimed in claim 4, wherein the one or more pre-travel promotional offers are facilitated to the user based on an estimation of the baggage weight of the user.

7. The method as claimed in claim 1, further comprising:
facilitating redemption of the one or more reward points accumulated by the user, wherein the one or more accumulated reward points are redeemed by the user using one of: a seat preference, a higher class lounge privileges, an assignment of the one or more reward points to another user, a purchase of an over-limit baggage weight, a purchase of an in-flight meal, a purchase of an in-flight itinerary payment, a cash redemption and a purchase from a different airline alliance.

8. The method as claimed in claim 1, wherein facilitating the reward tracking and redemption platform, further comprising:
facilitating at least one user interface for user registration on a user device; and
assigning the UAN to the user upon user registration.

9. The method as claimed in claim 1, further comprising:
deducting the one or more reward points based at least on difference between a higher baggage weight carried by the user and the baggage weight allowed by the airline enterprise of the purchased airline ticket.

10. A server system in a payment network, the server system comprising:
a communication interface configured to receive an airline ticket booking notification comprising a booking information of an airline ticket purchased by a user using a payment card;
a memory comprising executable instructions; and
a processor communicably coupled to the communication interface and configured to execute the instructions to cause the server system to at least:
using a payment card information of the payment card, check if a Universal Account Number (UAN) is assigned to the user;
if the UAN is assigned to the user, retrieve the UAN based on receiving the airline ticket booking notification;
if the UAN is not assigned to the user, assign the UAN to the user;
link the UAN to the purchased airline ticket; and
facilitate a reward tracking and redemption platform wherein the reward tracking and redemption platform at least comprises one or more reward points assigned to the UAN, the one or more reward points generated based at least on difference of a baggage weight carried by the user versus the baggage weight allowed by an airline enterprise of the purchased airline ticket.

11. The server system as claimed in claim 10, wherein the one or more reward points are generated based on a time-duration of a travel route retrieved from the booking information of the purchased airline ticket.

12. The server system as claimed in claim 11, wherein the one or more reward points are generated based on one of:
a frequency usage of the travel route;
a popularity of the travel route; and
a popularity of the airline enterprise.

13. The server system as claimed in claim 10, wherein the server system is further caused to:
facilitate one or more pre-travel promotional offers to the user via the airline enterprise for carrying an under-limit baggage weight, wherein the one or more pre-travel promotional offers are facilitated to the user based on a number of booked tickets for a travel route of the user.

14. The server system as claimed in claim 13, wherein the one or more pre-travel promotional offers are facilitated to the user based on an estimation of total baggage weight for the travel route of the user.

15. The server system as claimed in claim 13, wherein the one or more pre-travel promotional offers are facilitated to the user based on an estimation of the baggage weight of the user.

16. The server system as claimed in claim 10, wherein the server system is further caused to:
facilitate redemption of the one or more reward points accumulated by the user, wherein the one or more accumulated reward points are redeemed by the user using one of: a seat preference, a higher class lounge privileges, an assignment of the one or more reward points to another user, a purchase of an over-limit baggage weight, a purchase of an in-flight meal, a purchase of an in-flight itinerary payment, a cash redemption and a purchase from a different airline alliance.

17. The server system as claimed in claim 10, wherein for facilitating the reward tracking and redemption platform, the server system is further caused to:
facilitate at least one user interface for user registration on a user device; and
assign the UAN to the user upon user registration.

18. The server system as claimed in claim 10, wherein the server system is further caused to:
deduct the one or more reward points based at least on difference between a higher baggage weight carried by the user and the baggage weight allowed by the airline enterprise of the purchased airline ticket.

19. A computer program product comprising at least one non-transitory computer-readable storage medium, the computer-readable storage medium comprising a set of instructions, which, when executed by one or more processors in an electronic device, cause the electronic device to at least:
receive an airline ticket booking notification comprising a booking information of an airline ticket purchased by a user using a payment card;
using a payment card information of the payment card, check if a Universal Account Number (UAN) is assigned to the user;
if the UAN is assigned to the user, retrieve the UAN based on receiving the airline ticket booking notification;
if the UAN is not assigned to the user, assign the UAN to the user;
link the UAN to the purchased airline ticket; and
facilitate a reward tracking and redemption platform wherein the reward tracking and redemption platform at least comprises one or more reward points assigned to the UAN, the one or more reward points generated based at least on difference of a baggage weight carried by the user versus the baggage weight allowed by an airline enterprise of the purchased airline ticket.

20. The computer program product as claimed in claim 19, wherein the electronic device is caused to:
facilitate redemption of the one or more reward points accumulated by the user, wherein the one or more accumulated reward points are redeemed by the user using one of: a seat preference, a higher class lounge privileges, an assignment of the one or more reward points to another user, a purchase of an over-limit baggage weight, a purchase of an in-flight meal, a purchase of an in-flight itinerary payment, a cash redemption and a purchase from a different airline alliance.
